(19) United States
(12) Patent Application Publication
(10) Pub. No.: US 2011/0121782 A1
(43) Pub. Date: May 26, 2011

(54) Powering a Cordless Drill from AC Line Power

(76) Inventors: Douglas G. Marsh, Bethlehem, PA (US); Apparajan Ganesan, Austin, TX (US); Ashok Raghunathrao Saraf, Pune (IN); Kishore Chandrakant Jambhekar, Pune (IN)

(21) Appl. No.: 12/623,841

(22) Filed: Nov. 23, 2009

(51) Int. Cl. H02J 7/02; H02J 7/00

(52) U.S. Cl. 320/111; 320/114

(57) ABSTRACT

The present invention is an ac-to-dc adaptor capable of driving the drill unit of a cordless drill. In the preferred embodiment, the adaptor has essentially the same look and feel as the battery pack normally used with a cordless drill. The adaptor contains conventional electronics to convert an ac line power input into a dc output sufficient to power the drill unit. The invention applies to other cordless tools as well.

### CROSS-REFERENCE TO RELATED APPLICATIONS

Not applicable.

### BACKGROUND

1. Field of Invention

This invention relates to means for enabling a cordless drill to be powered from ac line voltage.

2. Description of Prior Art

Cordless drills, i.e., drills that are powered from battery packs, are in wide use worldwide. However, they suffer from one major deficiency: the lifetime of the battery is much less than the lifetime of the drill unit. While replacement batteries are available, they are typically priced sufficiently high that most people simply throw the entire product out and buy a new one.

In an on-line webcast by sponsored Micro Power, Inc. and hosted by EDN magazine, the following introduction was given:

### “Date: Jun. 17, 2009

### Time: 11 AM Pacific/2 PM Eastern

Duration: 60 minutes (including Live Q&A)
Applications with high voltage and capacity requirements are adopting Lithium-ion technology. High voltages require many cells in series, while high rate capability or capacity is achieved with many strings in parallel. Small battery packs, with less than 12 cells, can be assembled without balancing between the cells. However, issues associated with cell imbalance can be exacerbated in higher voltage battery arrays. Capacity fade is increased and cycle life is reduced when cells are assembled into arrays because of imbalance which develops over time, and is influenced by temperature variations or intense pulsing duty cycles.” Thus, for batteries above 12V, cost of the batteries, both as part of the drill purchase and as a replacement pack increases more than would be expected by simply realizing that the number of battery cells needed is a linear function of the battery voltage.

U.S. Pat. No. 7,540,334 B2 presents an approach to a battery powered or ac line powered drill/driver with a multiplicity of useful features not previously available in portable powered tools. However, nothing within this patent suggests any means whereby the tool could be interchangeably powered by a battery or from ac line power, particularly, through the use of the same or similar type of housing used to manufacture both. U.S. Pat. No. 7,489,111 B2 presents a concept in which powering can come from either a battery pack or from ac line power through an ac-to-dc convertor. This patent applies to situations in which the battery pack and ac-to-dc convertor are fully separate from the tool. There is no suggestion that the approach is backward compatible with existing tools. The patent specifically addresses the concept of the battery pack and ac-to-dc convertor being in a holster with short cords connecting the power sources to the tool, and this is cited as the advantage of the invention that results in a lighter and easier to handle tool.

### SUMMARY

The present invention is an ac-to-dc adaptor capable of driving the drill unit of a cordless drill. In the preferred embodiment, the adaptor has essentially the same look and feel as the battery pack normally used with a cordless drill. The adaptor contains conventional electronics to convert an ac line power input into a dc output sufficient to power the drill unit. A Provisional Patent Application for this invention was filed on Jul. 3, 2009 and given Application No. 61/222,987.

### OBJECTS AND ADVANTAGES

Accordingly, several objects and advantages of this invention are:
(a) The battery lifetime is increased since the user can choose either battery operation or line power operation when the latter is available.
(b) When used with the ac adaptor, the user has a drill that has essentially the same look and feel as when used in the battery operation mode.
(c) When the battery eventually wears out, the drill unit is still useful, and this reduces the negative impact on the environment that presently occurs when the drill unit is discarded before it has worn out.
(d) The adaptor is significantly lighter than the battery pack making it less tiring for the user.

### DRAWING FIGURES

FIG. 1. A conventional cordless drill.

FIG. 2. A cordless drill with the ac adaptor module replacing the battery pack.

FIG. 3. An alternate arrangement for the adaptor.

FIG. 4. Photograph of a cordless drill and a cordless drill with the ac adaptor.

FIG. 5. Photograph of the electronics inside an ac adaptor.

FIG. 6. The electronics of an adaptor connected to the cap of a battery pack.

FIG. 7. Adaptor and battery pack side-by-side.

### DESCRIPTION—PREFERRED EMBODIMENT

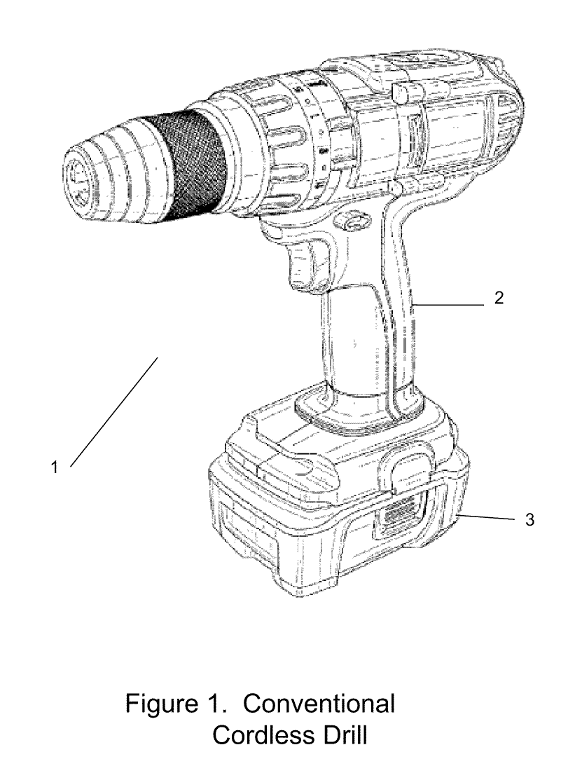

FIG. 1 shows a conventional cordless drill/driver, 1, or simply a cordless drill. The drill unit 2 and the battery pack 3 form the standard assembly typically purchased. Usually the cordless drill is sold with a battery charger and often with a second battery pack.

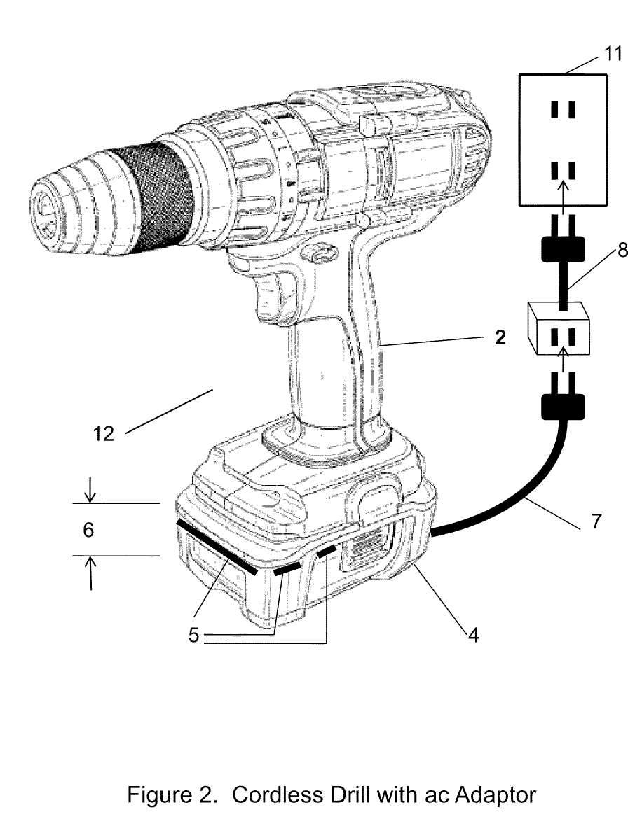

In the preferred embodiment in FIG. 2, the battery pack is replaced by a physically very similar housing 4 that contains ac-to-dc conversion electronics. Those skilled in the art will understand that the overall details of the design of the ac-to-dc convertor are not relevant to the invention, although careful attention to size and power dissipation are needed.

The adaptor housing 4 may differ from the standard battery pack in several minor ways. First, slots 5 may be cut or molded into the housing to dissipate heat. The location and size of these slots 5 vary depending on where the power dissipating elements in the adaptor 4 are located. Some adaptors 4 would not even need such slots 5 if the power dissipation inside the housing, which is dependent on both the details of the electronic design and the specific characteristics of the motor within the drill unit 2, is sufficiently low. The decision on the need for slots 5 is based on the allowable external temperature of the housing 4 when it is used at its maximum capability for an extended time. Those skilled in the art will understand that this determination is both a design consideration and a marketing consideration, with one essential characteristic being that the user will not find it too hot to grab and hold.

Second, in some cases, the battery pack housing may be too small to contain all the electronics need to power the drill unit 2. Then the adaptor housing 4 must be made larger. The preferred embodiment of this change is to increase the vertical dimension 6 of the adaptor. While other dimensions could be changed, the look and feel of the adaptor is less impacted by a change in the vertical dimension 6 than by changes to other dimensions.

Third, a power cord 7 is required. Usually a two wire power cord is sufficient since the adaptor 4 and drill unit 2 are typically in plastic housing. Those skilled in the art will understand that 3 wire power cords could also be used, at an increase in cost. Typically, the power cord will be in the range of 120 cm to 240 cm long since this is the length supplied by most corded tools. Frequently the user will need to add a standard extension cord 8 to connect the tool to the line power receptacle 11.

With the adaptor 4 and the battery pack 3 the user now has a choice of how to power the drill unit 2: the battery pack 3 can be used or, if line power is available, the line power adaptor 4 can be used. It is well known that the life of a battery pack 3 often depends on the number of recharges. If line power is used, the battery is not discharged, and need not be recharged, thus extending the life of the battery pack 3. The result is that the battery pack 3 does not get discarded as quickly, which is good for the environment. Further, the life of the drill unit 2 is extended since it is common for users to simply discard the entire drill 1 once the battery pack 3 has reached its end of life. This extension also is good for the environment.

Those skilled in the art will recognize that the slots 5 may not be sufficient to dissipate the heat generated by the electronics. In modern electronics with this problem a small fan is added to aid in the transfer of the heat out of the adaptor 4, and that can be done in this invention, although there is cost and size penalty.

For a cordless drill, users typically have two battery packs 3. Usually, the user will run one battery pack 3 until it is discharged and then replace it with the second battery pack 3. The discharged one will be placed in the charger which is supplied with the drill 1. Under very heavy use, the second one could be drained while the first one is still charging. After a few such iterations the user will no longer have sufficient charge in either one. If the user were to have an ac-to-dc adaptor 4 and a source of line power 11, work can continue.

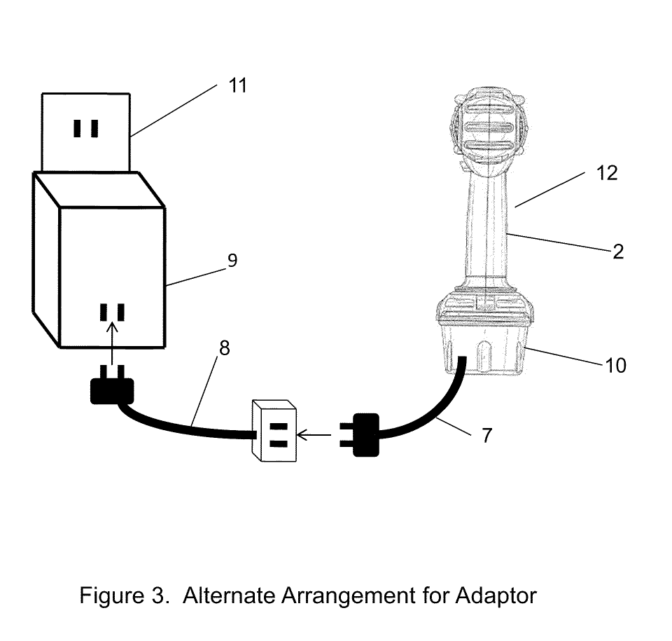

An alternative configuration, FIG. 3, is to place the electronics in a separate housing 9 that plugs directly into a wall outlet 11. Now the adaptor 10 is a dc-to-dc adaptor containing no electronics; it is simply connects the power cord 7 to drill unit 2. Of course, a standard extension cord 8 could be placed between the adaptor power cord 7 and the wall outlet 11.

Nothing precludes having the cord 7 long enough to not need an extension cord 8, but this would increase the cost of the adaptor and make storage of it require more space. Similarly, nothing would preclude connecting power cord 7 directly into adaptor 9 except for cost and storage issues.

In FIG. 3, the wall adaptor 9 is shown with a female connector and the dc-to-dc drill adaptor 10 is shown with a male plug; they can be reversed, although standard practice is as shown.

Those skilled in the art will recognize that nothing precludes omitting power cord 7 in either embodiment of the invention. In this case, the extension cord from the wall outlet 11 or from the second adaptor type 9 would plug into a male power connector that is integral to the adaptor 4 or 10. Such an arrangement can be found in some tools. However, some stress relief mechanism is needed at the adaptor 4 or 10 and this complicates both the plastic housing and the mechanical construction.

It is well known that ac-to-dc convertors typically contain two power supplies, one for the drill unit and one for the internal controller of the convertor. Further, some drills on the market contain LED lighting to help the user. There is nothing that precludes the design of the power supply for the controller to also supply power to those LEDs. This is dependent on the specific drill. Adding LEDs or some other lighting arrangement to the adaptor could also be done. LEDs for overload indication could also be added.

Those skilled in the art know that there are numerous other tools than drills that are available today in cordless form. This invention can equally well be used with those other tools.

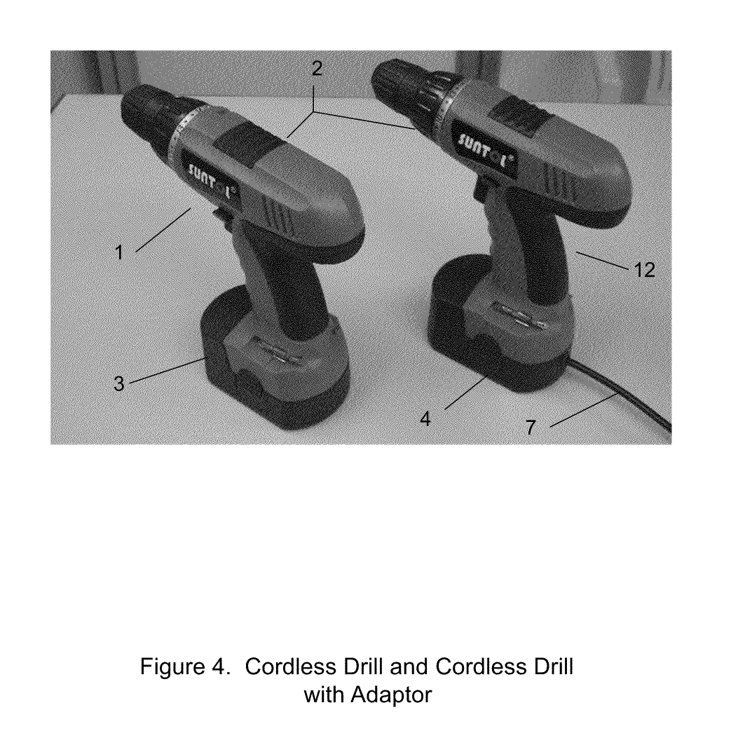

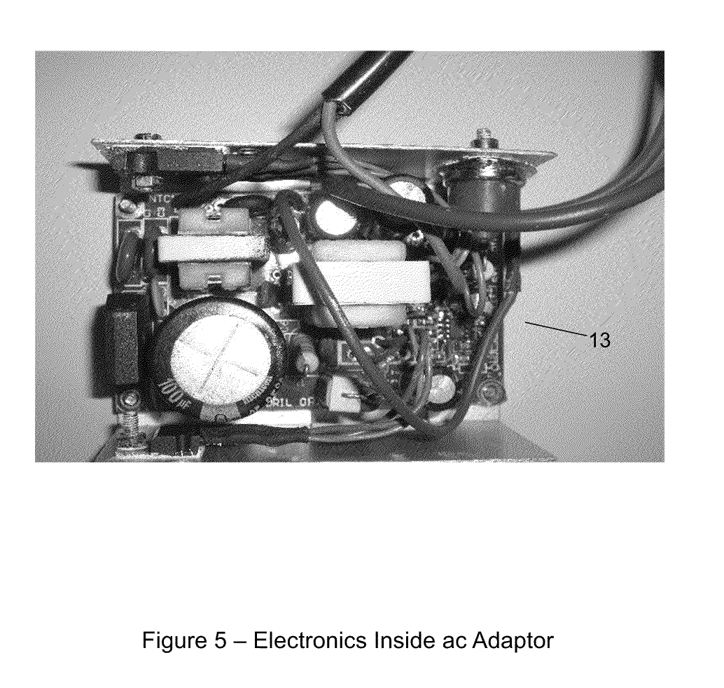

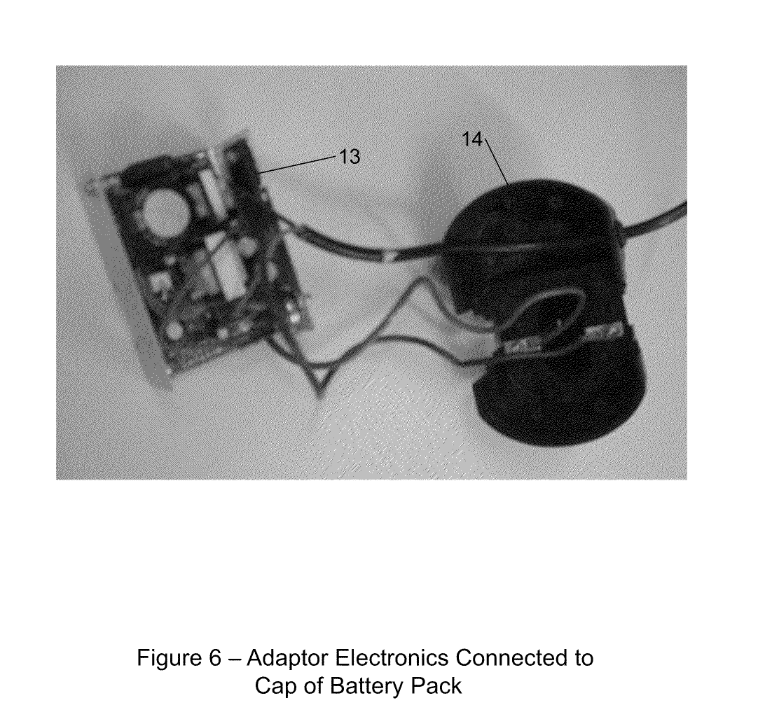

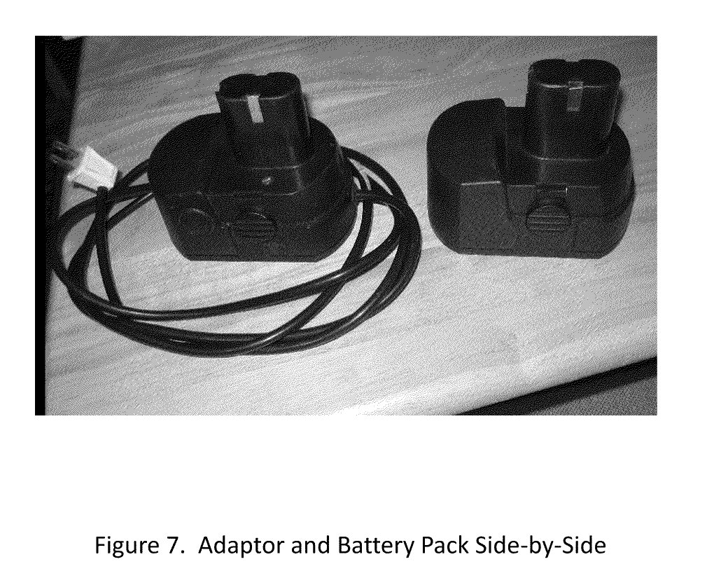

FIGS. 4 to 6 show, respectively, photographs of a cordless drill 1 powered by a battery pack 3 and a cordless drill 12 powered by an ac adaptor 4, the electronics 13 that are to be placed inside the battery pack housing, and the electronics 13 connected to the cap of the battery pack 14. In the embodiment shown in FIG. 4, the power cord 7 exits the battery pack housing 4 from the back. Those skilled in the art will understand that the cord 7 could exit from any side, or the top, or the bottom of the housing 4. FIG. 7 shows an ac adaptor and a battery pack side-by-side.

### Advantages

From the description above, a number of advantages of this invention are apparent:
(a) The battery lifetime is increased since the user can choose either battery operation or line power operation.
(b) When used with the ac adaptor, the user is presented with a tool that has essentially the same look and feel as when used in the battery operation mode.
(c) When the battery eventually wears out, the remainder of the drill is still useful, and this reduces it negative impact on the environment that presently occurs when the drill is discarded before it has worn out.
(d) The adaptor is significantly lighter than the battery pack making it less tiring for the user.

### CONCLUSIONS, RAMIFICATIONS, AND SCOPE

Accordingly, it is evident that this invention discloses a means for using the drill unit portion of a corded drill with ac line power, resulting in extending the life of both the battery pack and the drill unit, with the resultant savings to both the user and to the environment.

We claim:

1. A means of enabling a drill unit to be powered either by a battery pack or by ac line power wherein a first ac-to-dc adaptor is placed in essentially the same type of housing as said battery pack; said ac power being supplied to said first adaptor by a power cord, and said first adaptor containing electronics converting said ac line power to dc power sufficient to drive said drill unit and having electrical contacts to connect said dc power to said drill unit.

2. A first adaptor according to claim 1 wherein slots in said first adaptor are used to remove excess heat generated in said electronics of said first adaptor.

3. A first adaptor according to claim 2 wherein a small fan is included to aid in said removal of said excess heat.

4. A means of enabling said drill unit to be powered either by a second battery pack or by said ac line power wherein a second ac-to-dc adaptor is placed in a housing near said ac line power source whereby dc power output from said second ac-to-dc adaptor is run by a power cord to a third type adaptor, said third type adaptor connects said power cord to said drill unit.

5. An adaptor according to claim 4 wherein said power cord is an integral part of said second adaptor.

6. An adaptor according to claim 4 wherein said power cord is an integral part of said third adaptor.

7. An adaptor according to claim 4 wherein said power cord is an integral part of both said second and said third adaptors.

8. A means of enabling a tool unit to be powered either by a third battery pack or by ac line power wherein a third ac-to-dc adaptor is placed in essentially the same type of housing as said third battery pack; said ac power being supplied to said third adaptor by a power cord, and said third adaptor containing electronics converting said ac line power to dc power sufficient to drive said tool unit and having electrical contacts to connect said dc power to said tool unit.
